(19) United States
(12) Patent Application Publication
(10) Pub. No.: US 2002/0056793 A1
(43) Pub. Date: May 16, 2002

(54) Stands for supporting musical instruments or the like

(76) Inventor: Jonathan Arnold Bell, Long Beach, CA (US)

Correspondence Address: BLACKWELL SANDERS PEPER MARTIN LLP, 720 OLIVE STREET, SUITE 2400, ST. LOUIS, MO, 63101, US

(21) Appl. No.: 09/993,738

(22) Filed: Nov. 14, 2001

Related U.S. Application Data
(60) Provisional application No. 60/248,256, filed on Nov. 14, 2000.

(51) Int. Cl. A47F 7/00; F16M 11/38; F16M 11/00

(52) U.S. Cl. 248/176.1; 248/166; 211/85.6

(57) ABSTRACT

A stand for supporting a musical instrument, the stand comprising a front frame subassembly, a base frame subassembly, and a rear frame subassembly. These subassemblies are hinged and clipped together to form a self-supporting stand that supports the front frame subassembly with a rearwardly leaning planar front face. A bracket near the foot of the front frame subassembly carries most of the weight of the musical instrument supported by the stand, the remaining instrument weight being carried by the planar front face of the front frame subassembly. At least the top of the front frame subassembly is wider and higher than the width and height of the upper end of the musical instrument, and this protects the musical instrument against being dislodged from the stand by direct impacts from above, the side or the rear. The instrument stand is lightweight and easily collapsible for transport. Constructional details of the frame and joints are given, and decorative forms are also described. The instrument stand is of particular utility for protecting guitars, cellos, and other instruments with similarly extended necks. The stand can also be utilized as an impact-protective display stand.

### CROSS REFERENCE TO RELATED APPLICATION

This application claims the benefit of U.S. Provisional Application Serial No. 60/248,256 filed Nov. 14, 2000.

### BACKGROUND OF THE INVENTION

The invention relates to stands for supporting musical instruments or the like, and relates more particularly but not exclusively to a stand for supporting a musical instrument having an extended neck, for example a guitar or a cello.

These are occasions when a musical instrument is not in immediate use and can be put to one side by the player of the musical instrument, with the proviso that the instrument can be taken up again with minimum expenditure of time and effort. Such occasions might, for example, be immediately before and/or after a performance by the player as a solo performer, or as a member of a group, or as a member of an orchestra. Laying the musical instruments in the floor beside the player's performance location not only takes up considerable floor space, but also exposes the valuable instrument to serious damage by being kicked or stood upon. These disadvantages are reduced by placing the musical instrument upon an instrument stand which supports the musical instrument in a nearly upright position. However, with prior art instrument stands the musical instrument is exposed to the hazard of being knocked off the stand and consequently damaged, particularly by impact with the neck of the musical instrument. For example, consider the case of the interval in an orchestral performance wherein a subsequential number of musicians move across a crowded stage of limited dimensions, leaving their musical instruments on respective stands for post-interval use. In such a case, there is a high risk of impact with a musical instrument on its stand, and the consequent dislodgement of the musical instrument from its stand leading to impact damage of the musical instrument.

Even in the case of a single musician, e.g., a solo guitar player, there are similar risks (whether or not the probability of an undesirable impact with the musical instrument is similar), and a consequent need for a stand for supporting a guitar or other musical instrument, that provides better protection for the musical instrument than a prior art instrument stand.

### SUMMARY OF THE INVENTION

Accordingly, it is an object of the invention to provide a stand for supporting a musical instrument or the like, the stand supporting the musical instrument with a reduced risk of impact dislodgement of the musical instrument from the stand.

According to the first aspect of the present invention, there is provided a stand for supporting a musical instrument or the like in a substantially non-horizontal position, the stand having vertical and lateral dimensions which exceed the vertical and lateral dimension of the musical instrument at least in respect of those parts of the musical instruments most remote from the lower end of the musical instrument when supported in said substantially non-horizontal position whereby objects moving in a path towards vertical or lateral collision with said parts of the musical instrument most remote from the lower end will be intercepted by a vertical or lateral part of the stand.

Said stand is preferably shaped and dimensioned to support the musical instrument in a near-vertical position, and the stand preferably incorporates instrument carrying means disposed to contact the lower end of the musical instrument in a manner carrying a majority of the weight of the musical instrument. The instrument carrying means may comprise a cradle or a bracket.

In its simplest form, the stand in accordance with the invention comprises a vertically elongated support surface for the instrument, the support surface being aligned somewhat off-vertical so that the musical instrument can lean against the support surface during use of the stand, the support surface being taller than the musical instrument, and at least the upper reaches of the support surface being wider than the upper parts of the musical instrument. In the case where the musical instrument is a guitar or a cello or another musical instrument having an extended neck (or any other article having an analogous shape), at least the upper part of the stand is wider and taller than the neck of the musical instrument (or other article) such that the neck of the instrument is shielded by the stand against impact from any direction except the front. The lower parts of the stand may or may not be wider than the lower parts of the musical instrument since these lower parts of the instrument are closer to the weight-carrying part(s) of the stand which support the majority of the weight of the instrument and which thereby render the lower part of the instrument less susceptible than the neck to dislodgement by lateral impact. The support surface may be generally planar, and may have a ladder-like form comprising near-vertical side members joined by a plurality of substantially horizontal members to provide a substantially rigid support surface having a weight less than the weight of a solid support surface having similar overall dimensions and formed from the same material.

The stand may comprise a prop to hold the support surface in its off-vertical alignment. The lower end of the support surface may be linked to the lower end of the prop by means of a base member. The support surface, the prop, and the base member are preferably mutually coupled by coupling means which facilitate selective collapse and re-erection of the stand. The coupling means may comprise selectively operable latch means coupling the prop to the support surface, first hinge means coupling the lower end of the support surface to the front of the base member, and second hinge means coupling the lower end of the prop to the rear of the base member. The support surface may be structurally divided into an upper part and lower part mutually secured by a selectively operable latch means capable of either holding the upper part to the lower part for use of the stand or of allowing the upper part and the lower part to be relatively folded or mutually detached.

The lower end of the support surface and/or at least one part of the base member is/are preferably laterally widened at a location or location which rest(s) on a floor or other surface supporting the stand in use thereof whereby to inhibit lateral toppling of the stand.

Where the stand comprises instrument carrying means as aforementioned, the instrument carrying means is preferably foldably or detachably secured to the remainder of the stand to facilitate the selective collapse and re-erection of the stand.

According to a second aspect of the present invention there is provided the combination of a musical instrument or the like, and a stand therefor according to the first aspect of the invention. The musical instrument may be a guitar, or a cello, or any other form of musical instrument having an extended neck.

### BRIEF DESCRIPTION OF THE DRAWINGS

Embodiments of the invention will now be described by way of example with reference to the accompanying drawings wherein:

FIG. 1 is an elevation of a front frame subassembly of a first of embodiment of the guitar stand in accordance with the invention;

FIG. 2 is a plan view of a base frame subassembly of the first embodiment;

FIG. 3 is an elevation of a rear frame subassembly of the first embodiment;

FIG. 4 is a plan view, to an enlarged scale relative to the common scale of FIGS. 1-3, of a typical cross-member and side members of the subassemblies of FIGS. 1-3;

FIG. 5 semi-schematically illustrates the sub-assemblies of FIGS. 1-3 hinged together as a first stage in the procedure for rendering the first embodiment ready for use;

FIG. 6 is a schematic side elevation of the first embodiment in use as a stand and supporting a guitar;

FIG. 7 is a longitudinal section of a hinge utilized in the first embodiment;

FIG. 8 is a semi-schematic end view of one use of the FIG. 7 hinge in the first embodiment;

FIG. 9 is a semi-schematic end view of another use of the FIG. 7 hinge in the first embodiment;

FIG. 10 is a semi-schematic end view of one use of a compound variant of the FIG. 7 hinge in the first embodiment;

FIG. 11 is a semi-schematic end view of another use of the compound variant of the FIG. 7 hinge in the first embodiment; and

FIG. 12 is a semi-schematic end view of the attachment of the rear frame subassembly of FIG. 3 to the front frame subassembly of FIG. 1 in use of the first embodiment.

### DETAILED DESCRIPTION

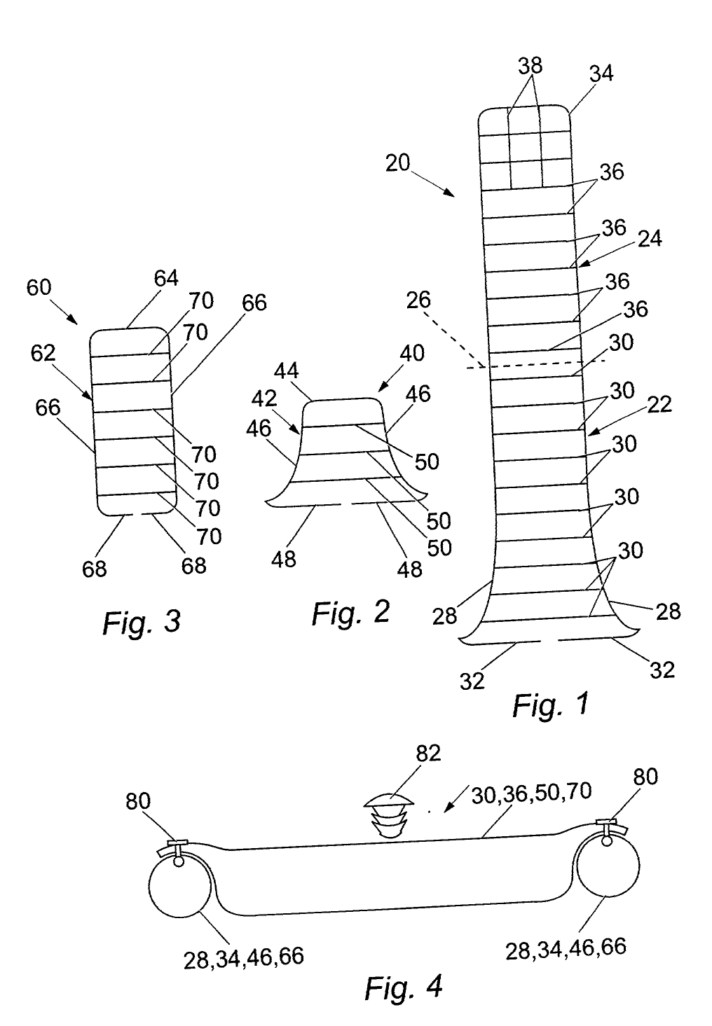

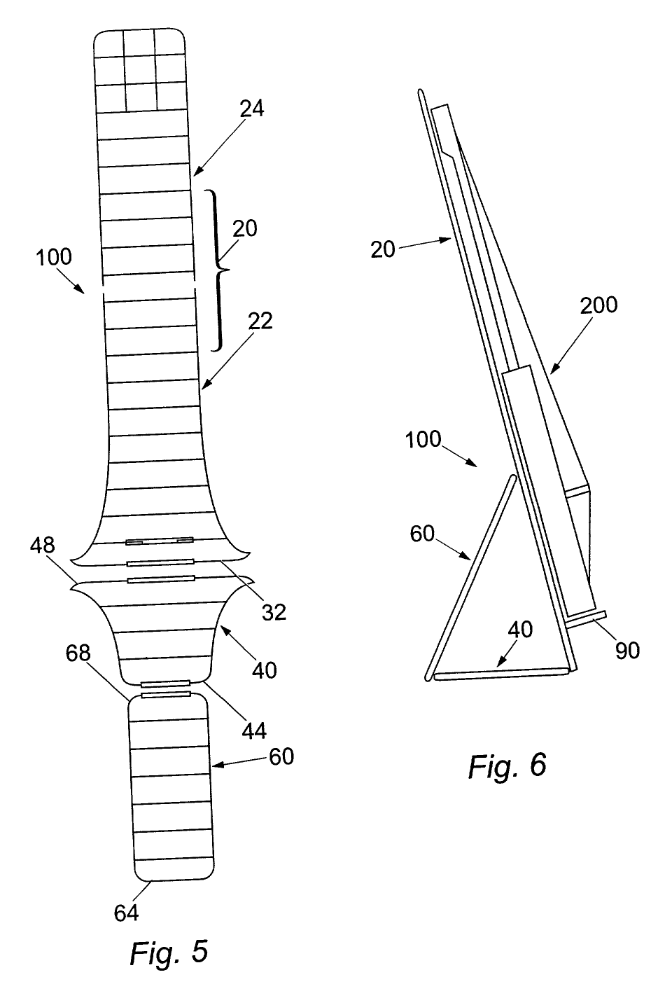

Referring first to FIG. 1, this is an elevation of a front frame subassembly 20 forming part of a first embodiment of a guitar stand in accordance with the invention (shown complete in FIGS. 5 and 6). The subassembly 20 is composed of a lower front frame 22 and an upper front frame 24 mutually conjoined along joint line 26 (this joint will subsequently be detailed with reference to FIG. 8)

The lower front frame 22 is formed of tubular metal side-rails 28 mutually conjoined by ten tubular metal laterals 30 to form a ladder-like structure.

The lower end of the side-rails 28 are bent laterally outwardly and then inwardly towards one another to form a lower end 32 of the frame 22, this lower end 32 being wider than the remainder of the subassembly 20. Methods of mutually securing the side-rails 20 and the laterals 30 will subsequently be described with reference to FIG. 4.

The upper front frame 24 comprises a peripheral member 34 of tubular metal bent to form an elongated “U” whose sides are conjoined by nine tubular metal laterals 36 to form a ladder-like structure. Methods of mutually securing the peripheral member 34 and the laterals 36 will subsequently be described with reference to FIG. 4. Two relatively short vertical members 38 overlap the upper end of the peripheral member 34 and the upper three laterals 36 to form a grid-like structure at the upper end of the upper front frame 24.

Referring now to FIG. 2, this is a plan view of a base frame subassembly 40 forming part of the first embodiment of the guitar stand in accordance with the invention. The subassembly 40 comprises a peripheral member 42 of tubular metal bent to form a closed loop. The portion 44 of the peripheral member 42 will form the rear edge of the base frame subassembly 40 in normal use of the guitar stand, and has a lateral extent about equal to the lateral extent of most of the guitar stand, e.g., the width of the upper front frame 24 (illustrated in FIG. 1). The portions 46 of the peripheral member 42 form the side edges of the base frame subassembly 40, and diverge laterally outwards with increasing distance from the rear portion 44. The side portions 46 are then inturned to form a relatively wide front edge 48 of the subassembly 40, the front edge 48 having a lateral extent matching the lower end 32 of the frame 22. In the assembled guitar stand, the lower end 32 and the front edge will be hinged together, as will subsequently be detailed with reference to FIG. 10. The side portions 46 of the peripheral member 42 are mutually conjoined by three tubular metal laterals 50 to form a short ladder-like structure. Methods of mutually securing the peripheral member 42 and the laterals 50 will subsequently be described with reference to FIG. 4.

Referring now to FIG. 3, this is an elevation of a rear frame subassembly 60 forming part of the first embodiment of a guitar stand in accordance with the invention. The subassembly 60 comprises a peripheral member 62 of tubular metal bent to form a closed loop. The peripheral member 62 can be notionally subdivided into an end portion 64 which will form the upper edge of the rear frame subassembly 60 in normal use of the guitar stand, mutually parallel side-rails 66 and an end portion 68 which will form the lower edge of the subassembly 60. The side-rails 66 are mutually conjoined by six tubular metal laterals 70 to form a ladder-like structure having a lateral extent similar to that of the upper front frame 24. Methods of mutually securing the peripheral member 62 and the laterals 70 will subsequently be described with reference to FIG. 4. In the assembled guitar stand, the lower end portion 68 of the rear frame subassembly 60 will be hinged to the rear portion 44 of the base frame subassembly 40, as will subsequently be detailed with reference to FIG. 11. Also, the upper frame subassembly 60 will be detachably coupled to the middle of the front frame subassembly 20, as will subsequently be described with reference to FIG. 12.

Referring now to FIG. 4, this illustrates one of many possible methods of connecting the cross-members or laterals 30, 36, 50 and 70 of the subassemblies 20, 40 and 60 to the respective side-rails or peripheral members 28, 34, 46 and 66. (The connection arrangement of FIG. 4 is shown to a much larger scale than the common scale of FIGS. 1, 2 and 3). The laterals 30, 36, 50 and 70 are cut to length from tubular metal stock, and opposite ends of the cut lengths are flattened and slightly dished. The prepared but still unconnected laterals are then superimposed on the tubes intended to form the side-rails or peripheral members 28, 34, 46, 66, in appropriate relative alignments and preferably with the guidance of a suitable jig (not shown). One or more holes are drilled or punched jointly through the overlapping portions of the superimposed tubes, which are then permanently conjoined by pop rivets 80, one rivet 80 extending through each of the holes. Any other suitable form of fastener may be used in place of the pop rivets 80, for example a barbed-stem plastics rivet 82 as separately depicted in FIG. 4. As an alternative to the use of fasteners, adhesives or welds may be used to conjoin the tubes forming each of the subassemblies 20, 40 and 60.

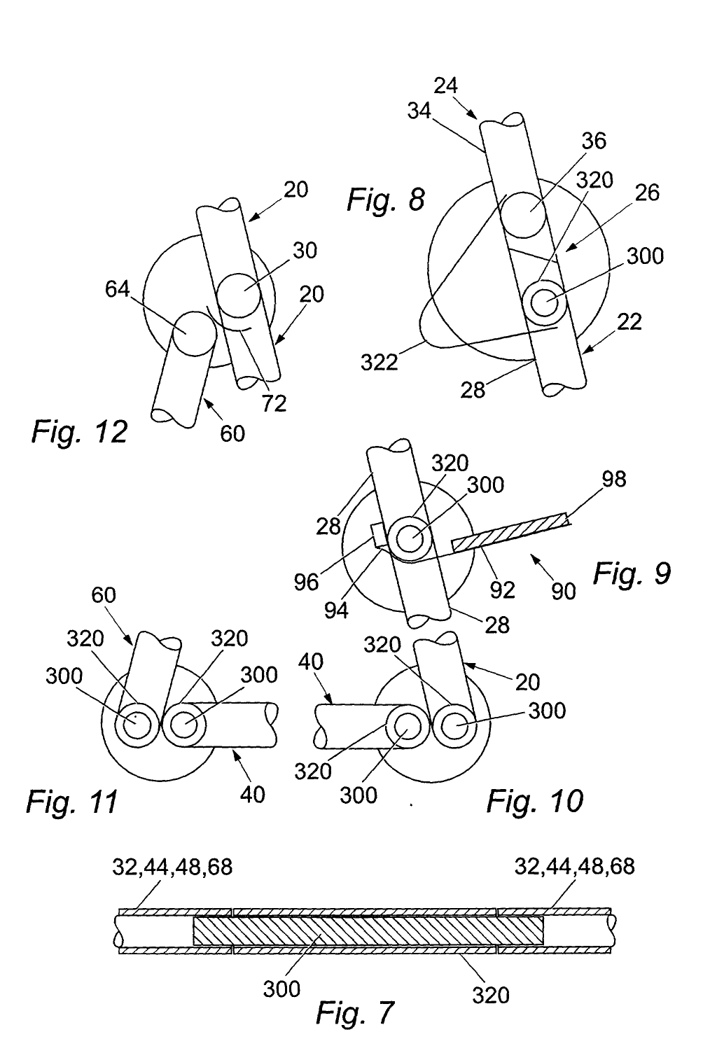

FIG. 5 shows the relative dispositions in the assembled but non-erected guitar stand of the lower front frame 22 and the upper front frame 24 (rigidly conjoined to form the planar front subassembly 20), together with the base frame subassembly 40 and the rear frame subassembly 60, these frames being shown slightly mutually separated for increased clarity. Hinges and other means for mutually coupling the frames are also omitted from FIG. 5 for clarity, but will subsequently be detailed with reference to FIGS. 7-12. Henceforth, the reference numeral 100 will be employed as a collective reference for the assembled guitar stand as illustrated in the accompanying drawings.

FIG. 5 illustrates the guitar stand 100 with its major components assembled but laid flat prior to being erected (as will be described below with reference to FIG. 6). In particular, FIG. 5 shows the lower end of the upper front frame 24 abutting the upper end of the lower front frame 22, the lower end 32 of the front frame subassembly 20 abutting the front edge 48 of the base frame subassembly 40, and the rear edge 44 of the base frame subassembly 40 abutting the lower edge 68 of the rear frame subassembly 60. (In FIG. 5, the subassemblies 40 and 60 are inverted with respect to their depictions in FIGS. 2 and 3 respectively).

FIG. 6 schematically depicts a side elevation of how the guitar stand 100 as assembled but laid flat in FIG. 5 is erected to form a support for a guitar 200. While the base frame subassembly 40 remains flat on the floor of the location wherein the stand is erected, the front frame subassembly 20 is pivoted upwardly about its lower end 32 until somewhat beyond vertical while the rear frame subassembly 60 is pivoted upwardly about its lower edge 68 until somewhat beyond vertical when its upper edge 64 abuts the rear face of the front frame subassembly 20, whereupon the upper edge 64 is detachably latched to the subassembly 20 (as will be detailed in FIG. 12) such that the rear frame subassembly 60 props the front frame subassembly 20 in a stable and load-resistant configuration. A small platform 90 is then folded down from its previous position stowed in the plane of the front frame subassembly. The platform 90 stands out at right angles from the tilted-back front face of the stand 100, in order to support the majority of the weight of the guitar 200, a minority of the weight of the guitar being supported by the tilted-back front face of the stand 100 (formed by the front face of the front frame subassembly 20). Details of the platform 90 will subsequently be described with reference to FIG. 9.

Referring now to FIG. 7, this is a longitudinal section of a hinge suitable for use in any of the hinged joints of the guitar stand 100. The end portions 32, 44, 48 and/or 68 of the subassemblies 20, 40 and 60 are cut away (or formed with suitable gaps), and a metal rod 300 of suitable diameter and length has one end inserted into one of the cut-away frame tubes. A tubular sleeve 320 of suitable diameter and length is fitted around the rod 300, and the other end of the rod 300 is fitted into the opposite cut-away frame tube to form the arrangement depicted in FIG. 7. The rod 300 is arranged to be non-rotatable in the frame tubes, either by selecting the external diameter of the rod 300 to be a tight fit in the bore of the frame tubes, or by crimping or swaging the frame tubes onto the rod ends, or by any other suitable technique. The sleeve 320 is arranged to be rotatable around the rod 300, for example by selecting the bore of the sleeve 320 to be a clearance fit on the external diameter of the rod 300. (Alternatively, the rod 300 could be made rotatable in the frame tubes and optionally also non-rotatable within the sleeve 320, but this alternative would prevent the use of the rod 300 to rigidly connect the opposing cut-away frame tube ends).

The use of the hinge arrangement described above with reference to FIG. 7 for forming the joint 26 mutually connecting the lower front frame 22 to the upper front frame 24 will now be described with reference to FIG. 8 which is a fragmentary side elevation, to an enlarged scale, of the joint 26. A hinge 300/320 as described in FIG. 7 is formed in the uppermost lateral 30 in the lower front frame 22. A metal bracket 322 rigidly links the sleeve 320 of this hinge to the lowest lateral 36 of the upper front frame 24, the bracket 322 being welded or otherwise secured to both the sleeve 320 and the lateral 36. Thereby the upper front frame 24 can pivot around the rod 300 set into the upper end of the lower front frame 22.

In order that the upper front frame 24 shall be retained in a fixed coplanar position with respect to the lower front frame 22, the contiguous ends of the side-rails 28 and the peripheral member 34 can be chamfered as shown in FIG. 8, and a latch (not shown) may also be provided for mutually locking the front frames 22 and 24 across the joint 26.

As an alternative to the hinge arrangement shown in FIG. 8 for mutually coupling the front frames 22 and 24, they could be detachably linked by any other suitable means, for example, pegs set into the end of one of the front frames and aligned for plug-fit insertion into matching sockets formed in the end of the other of the front frames.

The hinge arrangements described above with reference to FIG. 7 can also be utilized to attach the guitar-supporting platform 90 to the front frame assembly 20, as will now be detailed with reference to FIG. 9. The lowest lateral or cross-member 30 in the lower front frame 22 is cut away and provided with a hinge in the form of a rod 300 and a sleeve 320 as previously described with reference to FIG. 7. A bracket 92 is secured by a weld or by any other suitable means to the rotatable sleeve 320 such that the bracket 92 can be rotated between two positions, namely a stowed position flat against the lower front frame 22 (not shown in FIG. 9), and a deployed position in which the bracket 92 extends at right angles outwardly from the lower front frame 22 (as shown in FIG. 9). Rotation of the bracket 92 beyond the deployed position shown in FIG. 9 is prevented by a heel portion 94 in the inboard (socket) end of the bracket 92 contacting a stop block 96 affixed to the rear face of the lateral 30 to which the platform 90 is hinged. The upper face of the bracket 92 is covered by a glued-on felt pad 98 (or any other suitable cushioning material) such that the guitar 200 can rest on the platform 90 without thereby receiving scratches or other superficial damage.

By forming a hinge as described with reference to FIG. 7 in each of the adjacent parts of frame subassemblies that are to be hinged together to form adjacent sections of the guitar stand 100, and by mutually securing (e.g., by welding) the respective sleeves in each pair with the sleeves parallel, contiguous, and co-extensive (i.e., having a “figure-of-eight” cross-section), the sub-assemblies 20, 40 and 60 can be hinged together as described with reference to FIGS. 5 and 6, as will now be described with reference to FIGS. 10 and 11. In FIG. 10 such a double hinge is used to couple the lower end of the front frame subassembly 20 to the front edge of the base frame assembly 40, while in FIG. 11, an equivalent double hinge is used to couple the rear edge of the base frame subassembly 40 to the lower edge of the rear frame subassembly 60.

Referring now to FIG. 12, this is a semi-schematic end view of the arrangement for detachably attaching the upper end 64 of the rear frame subassembly 60 to the rear surface of the front frame subassembly 20. A metal clip 72 is welded or otherwise secured to the upper end portion 64 of the peripheral member 62 of the rear frame subassembly 60, with the clip 72 being dimensioned and aligned to clip around an appropriate one of the laterals or cross-members 30 comprised in the front frame subassembly 20. This enables the subassemblies of the guitar stand 100 as shown in FIG. 5 to be clipped together in the stable and self-supporting triangulated configuration shown in FIG. 6.

When a guitar 200 is supported on the stand 100 as schematically depicted in FIG. 6, the neck of the guitar 200 is protected against impacts from above, behind, and all sides except the front, because the stand 100, and particularly the front frame subassembly 20, is taller and wider than the guitar neck. The lower parts of the front frame subassembly 20 may or may not be wider than the body of the guitar, and so may or may not provide similar protection, but even if the guitar body lacks such protection, this is of relatively lower risk since impacts on lower portions of the guitar are less likely than neck impacts to knock the guitar 200 off its stand 100. The invention thus provides a guitar stand which gives improved protection to guitars from impacts, e.g. impacts with persons moving adjacent the stand.

Notwithstanding the improved protection provided by the instrument stand in accordance with the invention, it is of low-weight construction for ease of carriage, and can readily be collapsed to a convenient size for transport and storage, while remaining easily and quickly re-erectable without the use of tools. The appearance and other superficial aspects of the stand (e.g., color, albedo, texture, etc.) can readily be adapted by known techniques to a customer's requirements.

The stand of the invention will also provide improved protection to musical instruments other than guitars, e.g., to other stringed musical instruments such as cellos, and to stringed or non-stringed musical instruments having extended necks or equivalent portions susceptible to impact when lodged on an instrument stand.

While certain modification and variations of the invention have been described above, the invention is not restricted thereto. For example, while the guitar stand 100 has been described as being fabricated of tubular metal (e.g., of steel or aluminium), it could alternatively be fabricated of any other suitable material or combination of materials, for example, plastics (as an assembly of components or as a unitary moulding), wood, or other synthetic or natural materials (e.g., bamboo). The size and/or the shape of the stand can be varied to suit different musical instruments. The stand can be used as a display stand as well as being used as an accessory for a musician. The stand can be adapted to support articles other than musical instruments.

Other modifications and variations can be adopted without departing from the scope of the invention.

1. A stand for supporting a musical instrument or the like in a non-horizontal position, the musical instrument or its like having an extended neck, the stand being such that when the instrument is supported on the stand, the width and height of the stand adjacent the neck of the instrument are greater then the width and height of the neck of the instrument, respectively.

2. The stand as set forth in claim 1, wherein the stand comprises a vertically elongated support surface for the instrument, the support surface being inclined from the vertical so that the musical instrument can lean against the support surface during use of the stand, the support surface being taller than the musical instrument, and at least the upper reaches of the support surface being wider than the upper parts of the musical instrument.

3. The stand as set forth in claim 2 wherein the support surface has a ladder-like form comprising near-vertical side members joined by a plurality of substantially horizontal members to provide a substantially rigid support surface.

4. The stand as set forth in claim 2, wherein the stand further comprises a prop to hold the support surface in an off-vertical alignment, and wherein the lower end of the support surface is linked to the lower end of the prop by means of a base member.

5. The stand as set forth in claim 4, wherein the support surface, the prop, and the base member are mutually coupled by coupling means which facilitate selective collapse and re-erection of the stand, the coupling means comprising selectively operable latch means coupling the prop to the support surface, first hinge means coupling the lower end of the support surface to the front of the base member, and second hinge means coupling the lower end of the prop to the rear of the base member.

6. The stand as set forth in claim 2 wherein the lower end of the support surface and at least one part of the base member are laterally widened at locations which rest on a floor or other surface supporting the stand in use thereof whereby to inhibit lateral toppling of the stand.

7. The stand for supporting a musical instrument or the like in a substantially non-horizontal position, the stand having vertical and lateral dimensions which exceed the vertical and lateral dimensions of the musical instrument at least in respect of those parts of the musical instruments most remote from the lower end of the musical instrument when supported in said substantially non-horizontal position whereby objects moving in a path towards vertical or lateral collision with said parts of the musical instrument most remote from the lower end will be intercepted by a vertical or lateral part of the stand.

8. The stand as set forth in claim 7, wherein said stand is shaped and dimensioned to support the musical instrument in a near-vertical position.

9. The stand as set forth in claim 7, wherein the stand incorporates instrument carrying means disposed to contact the lower end of the musical instrument in a manner carrying a majority of the weight of the musical instrument.

10. The stand as set forth in claim 9, wherein the instrument carrying means comprises a cradle.

11. The stand as set forth in claim 9, wherein the instrument carrying means comprises a bracket.

12. The stand as set forth in claim 7, wherein the stand comprises a vertically elongated support surface for the instrument, the support surface being inclined from the vertical so that the musical instrument can lean against the support surface during use of the stand, the support surface being taller than the musical instrument, and at least the upper reaches of the support surface being wider than the upper parts of the musical instrument.

13. The stand as set forth in claim 12, wherein the support surface is generally planar.

14. The stand as set forth in claim 13, wherein the support surface has a ladder-like form comprising near-vertical side members joined by a plurality of substantially horizontal members to provide a substantially rigid support surface.

15. The stand as set forth in claim 12, wherein the stand comprises a prop to hold the support surface in its off-vertical alignment.

16. The stand as set forth in claim 15, wherein the lower end of the support surface is linked to the lower end of the prop by means of a base member.

17. The stand as set forth in claim 16, wherein the support surface, the prop, and the base member are mutually coupled by coupling means which facilitate selective collapse and re-erection of the stand.

18. The stand as set forth in claim 17, wherein the coupling means comprises selectively operable latch means coupling the prop to the support surface, first hinge means coupling the lower end of the support surface to the front of the base member, and second hinge means coupling the lower end of the prop to the rear of the base member.

19. The stand as set forth in claim 12, wherein the support surface is structurally divided into an upper part and lower part mutually secured by a selectively operable latch means capable of either holding the upper part to the lower part for use of the stand or of allowing the upper part and the lower part to be relatively folded.

20. The stand as set forth in claim 12, wherein the support surface is structurally divided into an upper part and lower part mutually secured by a selectively operable latch means capable of either holding the upper part to the lower part for use of the stand or of allowing the upper part and the lower part to be mutually detached.

21. The stand as set forth in claim 12, wherein the lower end of the support surface is laterally widened at a location which rests on a floor or other surface supporting the stand in use thereof whereby to inhibit lateral toppling of the stand.

22. The stand as set forth in claim 12 wherein the lower end of at least one part of the base member is laterally widened at a location which rests on a floor or other surface supporting the stand in use thereof whereby to inhibit lateral toppling of the stand.

23. The stand as set forth in claim 9, wherein the instrument carrying means is foldably secured to the remainder of the stand to facilitate the selective collapse and re-erection of the stand.

24. The stand as set forth in claim 9, wherein the instrument carrying means is detachably secured to the remainder of the stand to facilitate the selective collapse and re-erection of the stand.

25. A combination of a musical instrument and a stand, the musical instrument being a stringed instrument having a body and an extended neck, and the stand being such that when the instrument is supported on the stand, the width and height of the stand adjacent the neck of the instrument are greater then the width and height of the neck of the instrument, respectively, and wherein at least the upper part of the stand is wider and taller than the neck of the musical instrument such that the neck of the instrument is shielded by the stand against impact from any direction except the front.

26. The combination of a musical instrument and a stand as set forth in claim 25, wherein the musical instrument is a guitar.
